(19) United States
(12) Patent Application Publication
(10) Pub. No.: US 2026/0369210 A1
(43) Pub. Date: Nov. 19, 2026

(54) ENERGY EFFICIENT MULTI-PRIMARY WIDE GAMUT DISPLAY

(71) Applicant: InterDigital CE Patent Holdings, SAS, Paris (FR)

(72) Inventors: Erik REINHARD, Hédé-Bazouges (FR); Laurent BLONDÉ, THORIGNE-FOUILLARD (FR); Claire-Helene DEMARTY, MONTREUIL LE GAST (FR); Olivier LE MEUR, TALENSAC (FR); Franck AUMONT, VERN SUR SEICHE (FR); Zoubida AMEUR, CESSON SEVIGNE (FR)

(21) Appl. No.: 19/126,391

(22) PCT Filed: Nov. 7, 2023
(86) PCT No.: PCT/EP2023/080937

§ 371 Date: May 1, 2025

(30) Foreign Application Priority Data
Nov. 10, 2022 (EP) 22315273.7

(51) Int. Cl. G09G 3/20

(52) U.S. Cl. CPC G09G 3/2096; G09G 2300/0452; G09G 2330/021; G09G 2340/06

(57) ABSTRACT

Apparatuses and methods are disclosed including techniques for driving a multi-primary display. The disclosed techniques include obtaining a pixel color of a content to be displayed. The display is configured to reproduce the pixel color using a combination of subpixel units (252, 254, 256, 262, 264, 266) that generate light at respective spectral emission breadths. The techniques further include selecting a combination of the subpixel units (262, 264, 266) having a wide emission spectra and a narrow color gamut and that consumes least energy. The selected combination of the subpixel units is then used to reproduce the pixel color on the display.

### CROSS REFERENCE TO RELATED APPLICATIONS

This application claims the benefit of European Application No. 22315273.7, filed on Nov. 10, 2022, which is incorporated herein by reference in its entirety.

### BACKGROUND

Most energy consumed by display devices, such as a television display, is expended on producing light. The more saturated the display's color primaries (that is, the wider the display's color gamut) used to reproduce an image pixel are, the more energy is needed to generate the light required for such reproduction. A wide gamut display thus consumes more energy than a display that utilizes a narrower gamut and this even when displaying narrow gamut colors. On top of standard gamut colors, a wide gamut display supports reproduction of content having highly chromatic pixels. In the case of such content, however, many of the pixels may be pixels with low chromaticity, and, therefore, can be reproduced using a smaller gamut. Hence, displaying those pixels on a wide gamut display leads to unnecessarily high energy consumption.

### SUMMARY

In this disclosure, aspects of an energy efficient multi-primary display system are described. Generally, a displayed image pixel is generated by light sources, each of which is used to reproduce a color component of the image pixel. According to aspects disclosed herein, more than one light source can be used to reproduce a color component of a pixel. Such light sources may have the same or a similar peak spectral response, but with a different spectral response breadth. For example, two light sources can be used to reproduce a color component (e.g., red), both having a peak spectral response associated with the color component, yet one light source may have a narrow spectral response and the other may have a wide spectral response. Generating light with a wide spectral response is more energy efficient than generating light with a narrow spectral response. Therefore, to reduce the display's energy consumption level, the light source with the narrow spectral response can be used to reproduce the highly chromatic portion of the content, whereas the light source with the wide spectral response can be used to reproduce the remaining (less saturated) portion of the content. Depending on the level of chromaticity of a pixel's color components, different respective light sources of the display can be used to reproduce that pixel. Thus, when a pixel's color component is sufficiently de-saturated, a light source with a wide spectral response can be selected to reproduce this color component because that light source consumes less energy than a light source with a narrow spectral response.

Aspects disclosed in the present disclosure describe methods for driving a multi-primary display. The methods comprise obtaining a pixel color of a content to be displayed. The display is configured to reproduce the pixel color using a combination of subpixel units that generate light at respective spectral emission breadths. The methods further comprise selecting a combination of the subpixel units. The selected combination of the subpixel units is the combination that consumes least energy. The selected combination of the subpixel units is then used to reproduce the pixel color on the display.

Aspects disclosed in the present disclosure describe an apparatus for driving a multi-primary display. The apparatus comprises at least one processor and memory storing instructions. The instructions, when executed by the at least one processor, cause the apparatus to obtain a pixel color of a content to be displayed. The display is configured to reproduce the pixel color using a combination of subpixel units that generate light at respective spectral emission breadths. The instructions further cause the apparatus to select a combination of the subpixel units. The selected combination of the subpixel units is the combination that consumes least energy. The selected combination of the subpixel units is then used by the apparatus to reproduce the pixel color on the display.

Aspects disclosed in the present disclosure describe a non-transitory computer-readable medium comprising instructions executable by at least one processor to perform methods for driving a multi-primary display. The methods comprise obtaining a pixel color of a content to be displayed. The display is configured to reproduce the pixel color using a combination of subpixel units that generate light at respective spectral emission breadths. The methods further comprise selecting a combination of the subpixel units. The selected combination of the subpixel units is the combination that consumes least energy. The selected combination of the subpixel units is then used to reproduce the pixel color on the display.

Furthermore, aspects disclosed in the present disclosure describe a multi-primary display apparatus. The multi-primary display apparatus comprises a display panel including pixel units. Where a pixel unit, of the pixel units, is configured to reproduce a respective pixel color and comprises subpixel units configured to generate light at respective spectral emission breadths. According to aspects disclosed herein, the multi-primary display apparatus further comprises a driver. The driver is configured to select a combination of the subpixel units of the pixel unit; the selected combination of the subpixel units consumes least energy. The selected combination of the subpixel units is used to reproduce the pixel color.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

FIG. 1 is a block diagram of an example system, according to aspects of the present disclosure.

FIG. 2 is a block diagram of an example multi-primary display system, according to aspects of the present disclosure.

FIG. 3 illustrates an example chromaticity diagram, according to aspects of the present disclosure.

FIG. 4 is a flowchart of an example method for selecting primaries of a multi-primary display utilizing BT.2020 and BT.709 gamuts, according to aspects of the present disclosure.

FIG. 5 is a flowchart of an example method for selecting primaries of a multi-primary display utilizing narrow and wide gamuts, according to aspects of the present disclosure.

FIG. 6 illustrates color gamuts, according to aspects of the present disclosure.

FIG. 7 illustrates color gamuts, according to aspects of the present disclosure.

FIG. 8 is a flowchart of an example method for selecting primaries of a multi-primary display utilizing narrow and wide gamuts, according to aspects of the present disclosure.

FIG. 9 illustrates color gamuts, according to which aspects of the present embodiments can be implemented.

FIG. 10 is a flowchart of an example method for selecting primaries of a multi-primary display utilizing multiple gamuts, according to aspects of the present disclosure.

FIG. 11 is a flowchart of an example method for driving a multi-primary display, according to aspects of the present disclosure.

### DETAILED DESCRIPTION

Multi-primary displays are commonly used to render high quality content. These displays utilize a wider color gamut, having more than three primaries, each of which with a different spectral peak. This can be achieved, for example, with multiple projectors, where one projector employs red, green, and blue filters, and a second projector employs other color filters, such as yellow, purple, and cyan filters. In the case of television displays, for example, Sharp's Quattron technology offers four-primary displays, utilizing yellow, red, green, and blue primaries to render each pixel. Five-primary displays were also developed by Sharp that utilize red, green, blue, cyan, and yellow primaries to render each pixel. In another example, OLED displays, developed by LG, use red, green, and blue primaries as well as a white primary. The white primary helps to increase the display's brightness and to reduce the energy required to display de-saturated content. See, Spindler JP at el., System considerations for RGBW OLED displays, Journal of the Society for Information Display 14, no. 1 (2006): 37-48. Aspects disclosed herein can be used to further reduce the energy required to display de-saturated content and can be applied to OLED displays as well as to LCD displays.

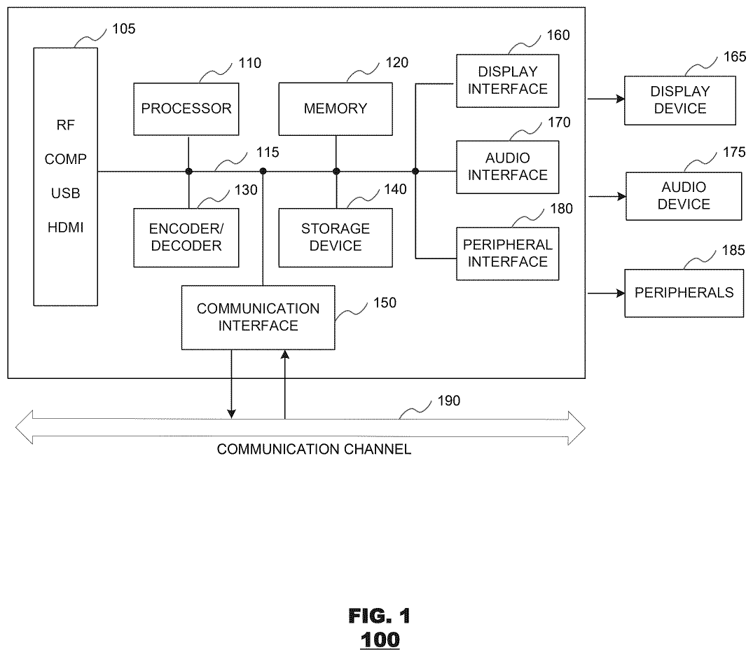

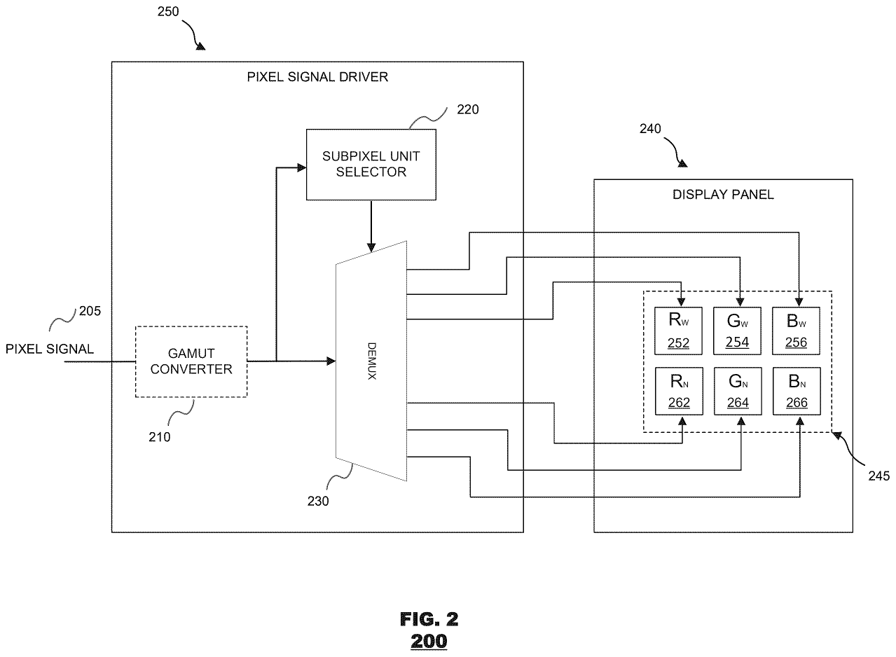

Aspects of the present disclosure describe techniques for reducing the energy consumption level of a multi-primary display. A system for processing and displaying content is generally described in reference to FIG. 1, followed by description of the aspects of the present disclosure, described in reference to FIGS. 2-11.

FIG. 1 illustrates a block diagram of an example system 100. System 100 can be embodied as a device including the various components described below and can be configured to perform one or more of the aspects described in this application. Examples of such devices, include, but are not limited to, various electronic devices such as personal computers, laptop computers, smartphones, tablet computers, digital multimedia set-top boxes, digital television receivers, personal video recording systems, connected home appliances, and servers. Elements of system 100, singly or in combination, can be embodied in a single integrated circuit, multiple integrated circuits, and/or discrete components. For example, in at least one embodiment, the processing and encoder/decoder elements of system 100 are distributed across multiple integrated circuits and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 that can be configured to execute instructions loaded therein for implementing, for example, the various aspects described in this application. Processor 110 can include embedded memory, input and output interfaces, and various other circuitries as known in the art. The system 100 includes at least one memory 120 (e.g., a volatile memory device and/or a non-volatile memory device). System 100 includes a storage device 140, which can include non-volatile memory and/or volatile memory, including, for example, EEPROM, ROM, PROM, RAM, DRAM, SRAM, flash, magnetic disk drives, and/or optical disk drives. The storage device 140 can be an internal storage device, an attached storage device, and/or a network accessible storage device, for example.

System 100 includes an encoder/decoder module 130 configured to process data to provide encoded video data or decoded video data. The encoder/decoder module 130 can include its own processor and memory. The encoder/decoder module 130 represents module(s) that can be included in a device to perform encoding and/or decoding functions. Additionally, the encoder/decoder module 130 can be implemented as a separate element of system 100 or can be incorporated within processor 110 as a combination of hardware and software as known to those skilled in the art.

Program code that is to be loaded into processor 110 or into encoder/decoder 130 to perform the various aspects described in this application can be stored in a storage device 140 and subsequently loaded into memory 120 for execution by processor 110. In accordance with various embodiments, one or more of processor 110, memory 120, storage device 140, and encoder/decoder module 130 can store one or more of various items during the performance of the processes described in this application. Such stored items can include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing functions that are needed during encoding or decoding. In other embodiments, however, memory external to the processing device (where, for example, the processing device can be either the processor 110 or the encoder/decoder module 130) can be used for one or more of these functions. The external memory can be the memory 120 and/or the storage device 140 that may comprise, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations.

The input to the elements of system 100 can be provided through various input devices as indicated in block 105. Such input devices include, but are not limited to, (i) an RF portion that receives an RF signal transmitted, for example, over the air by a broadcaster, (ii) a Composite input terminal (COMP), (iii) a USB input terminal, and/or (iv) an HDMI input terminal.

In various embodiments, the input devices of block 105 have associated respective input processing elements as known in the art. For example, the RF portion can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select, for example, a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements that perform these functions, for example, frequency selectors, signal selectors, band-limiters, channel selectors, filters, downconverters, demodulators, error correctors, and demultiplexers. The RF portion can include a tuner that performs some of these functions, including, for example, down-converting the received signal to a lower frequency (for example, an intermediate frequency or a near-baseband frequency) or to a baseband. In one set-top box embodiment, the RF portion and its associated input processing element receive an RF signal transmitted over a wired (for example, cable) medium, and perform frequency selection by filtering, down-converting, and filtering again to a desired frequency band. Various embodiments rearrange the order of the above-described (and other) elements, remove some of these elements, and/or add other elements performing similar or different functions. Added elements can include inserting elements in between existing elements, for example, inserting amplifiers and an analog-to-digital converter. In various embodiments, the RF portion includes an antenna.

Additionally, the USB and/or HDMI terminals can include respective interface processors for connecting system 100 to other electronic devices across USB and/or HDMI connections. It is to be understood that various aspects of input processing, for example, Reed-Solomon error correction, can be implemented, for example, within a separate input processing integrated circuit or within processor 110 as necessary. Similarly, aspects of USB or HDMI interface processing can be implemented within separate interface integrated circuits or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 can be provided within an integrated housing. Within the integrated housing, the various elements can be interconnected and transmit data therebetween using a suitable connection arrangement 115, for example, an internal bus as known in the art, including the I2C bus, wiring, and printed circuit boards.

The system 100 includes a communication interface 150 that enables communication with other devices via communication channel 190. The communication interface 150 can include, but is not limited to, a transceiver configured to transmit and to receive data over communication channel 190. The communication interface 150 can include, but is not limited to, a modem or network card. The communication channel 190 can be implemented, for example, within a wired and/or a wireless medium.

Data are streamed to the system 100, in various embodiments, using a Wi-Fi network such as IEEE 802.11. The Wi-Fi signal of these embodiments is received over the communication channel 190 and the communication interface 150 which are adapted for Wi-Fi communications. The communication channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 can provide an output signal to various output devices, including a display device 165, an audio device (e.g., speaker(s)) 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display device 165, the audio device 175, or other peripheral devices 185 using signaling such as AV.link, CEC, or other communication protocols that enable device-to-device control with or without user intervention. The output devices can be communicatively coupled to system 100 via dedicated connections through respective interfaces 160, 170, and 180. Alternatively, the output devices can be connected to system 100 using the communication channel 190 via the communication interface 150. The display device 165 and the audio device 175 can be integrated in a single unit with the other components of system 100 in an electronic device, for example, a television. In various embodiments, the display interface 160 includes a display driver, for example, a timing controller (T Con) chip.

The display device 165 and the audio device 175 can alternatively be separate from one or more of the other components, for example, if the RF portion of input 105 is part of a separate set-top box. In various embodiments in which the display device 165 and the audio device 175 are external components, the output signal can be provided via dedicated output connections, including, for example, HDMI ports, USB ports, or COMP outputs.

FIG. 2 is a block diagram of an example multi-primary display system 200. This display system 200 may be the display device 165 or other subsystems of system 100 of FIG. 1. As illustrated, the display system 200 includes a pixel signal driver 250 and a display panel 240, of which an example for one pixel unit 245 is shown. The pixel signal driver 250 is configured to drive a received pixel signal 205, representing an image pixel from a content to be displayed, into a respective pixel unit 245 within the display panel 240. Operations described herein that can be performed by the pixel signal driver 250 with respect to the received pixel signal 205 and its respective pixel unit 245 are similarly applicable to other received pixel signals (representative of other image pixels from the content to be displayed) and their respective pixel units within the display panel 240. The functionality of the pixel signal driver 250, as described herein, can be implemented by a software component, a firmware component, or a hardware component that is internal to the multi-primary display system 200 or external to it (e.g., executed by the processor 110 of FIG. 1).

According to aspects disclosed herein, an image pixel 205 can be reproduced (rendered) using all or a subset of the available subpixel units (also referred to herein as the display's primaries) in a respective pixel unit 245. In the example of FIG. 2, the available subpixel units can include a pair of red subpixel units 252, 262, a pair of green subpixel units 254, 264, and a pair of blue subpixel units 256, 266. These subpixel units include respective light sources with different spectral peak and spectral breadth. Note that the subpixel units with the wide spectral response 262, 264, 266 can reproduce content within a narrower gamut, while the subpixel units with the narrow spectral response 252, 254, 256 can reproduce content within a wider gamut. Thus, to reproduce the red color component of a pixel, a pair of subpixel units R_{W} 252 and R_{N} 262 are available that have the same (or a similar) spectral emission peaks (corresponding to the red primary), but one, R_{W} 252, has a narrow emission spectrum and one, R_{N} 262, has a wide emission spectrum, respectively. To reproduce the green color component of the pixel, a pair of subpixel units G_{W} 254 and G_{N} 264 are available that have the same (or a similar) spectral emission peaks (corresponding to the green primary), but one, G_{W} 254, has a narrow emission spectrum and one, G_{N} 264, has a wide emission spectrum, respectively. Similarly, to reproduce the blue color component of the pixel, a pair of subpixel units B_{W} 256 and B_{N} 266 are available that have the same (or a similar) spectral emission peaks (corresponding to the blue primary), but one, B_{W} 256, has a narrow emission spectrum and one, B_{N} 266, has a wide emission spectrum, respectively. In the general case, a pixel unit 245 can include any number of subpixel units, each configured to generate light, consuming respective energy level, at respective spectral emission peak (e.g., associated with a color component such as red, green, blue, yellow, purple, cyan, or white) and at respective spectral emission breadth.

Hence, the subpixel units with respective narrow emission spectra 252, 254, 256 can reproduce highly chromatic colors, and, therefore, can be used to reproduce content that requires a wide color gamut. The subpixel units with respective wide emission spectra 262, 264, 266 can only reproduce colors with relatively low chromaticity, and, therefore, can be used to reproduce content that is within a narrow color gamut. Since most pixels in a typical content are not highly chromatic, a large portion of the content can be reproduced using the subpixel units with the wide emission spectra 262, 264, 266. When displaying such content, by selecting to use subpixel units with narrow emission spectra 252, 254, 256 only for the reproduction of those pixels that cannot be reproduced by the subpixel units with the wide emission spectra 262, 264, 266, the overall energy spent to reproduce the content can be reduced. This is because subpixel units with wide emission spectra consume less energy than subpixel units with narrow emission spectra. The same principle can be applied to any number of primaries, each of which associated with subpixel units that are configured to emit lights with different respective spectral breadths or consume different respective levels of energy.

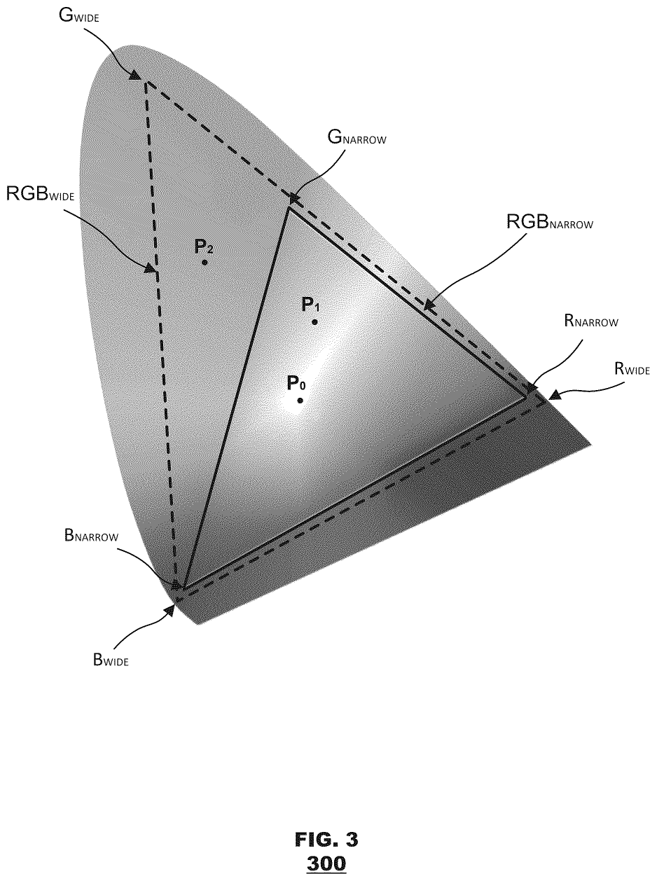

FIG. 3 illustrates an example chromaticity diagram 300. A chromaticity diagram describes a color space. Colors along the boundary of the diagram represent primary (pure) colors associated with respective light frequencies within the visible light spectrum, typically, measured by their wavelength (nanometers (nm))—such as the red primary color (650 nm), the green primary color (550 nm), and the blue primary color (450 nm). Other colors within the chromaticity diagram can be generated using primary colors at different intensities. As illustrated, pixel values P₀, P₁, and P₂ are located at different positions within the chromaticity diagram, each having different hues and saturation levels. An image content can be reproduced by a display within a color gamut that is, typically, limited by the display's imaging technology. For example, a wide gamut (denoted RGB_{wide}), as illustrated, is confined by a triangle defined by the primaries: R_{wide}, G_{wide}, and B_{wide}. Similarly, a narrower gamut (denoted RGB_{narrow}), as illustrated, is confined by a triangle defined by the primaries: R_{narrow}, G_{narrow}, and B_{narrow}. As illustrated, pixel value P₁=[P_{R}, P_{G}, P_{B}]₁ is located inside the narrow color gamut, while pixel value P₂=[P_{R}, P_{G}, P_{B}]₂ is located outside the narrow color gamut. According to the example of FIG. 2, the subpixel units with the wide emission spectra 262, 264, 266 can be used to reproduce a pixel color within a narrow gamut, RGB_{narrow}, while the subpixel units with the narrow emission spectra 252, 254, 256 can be used to reproduce a pixel color within a wide gamut, RGB_{wide}.

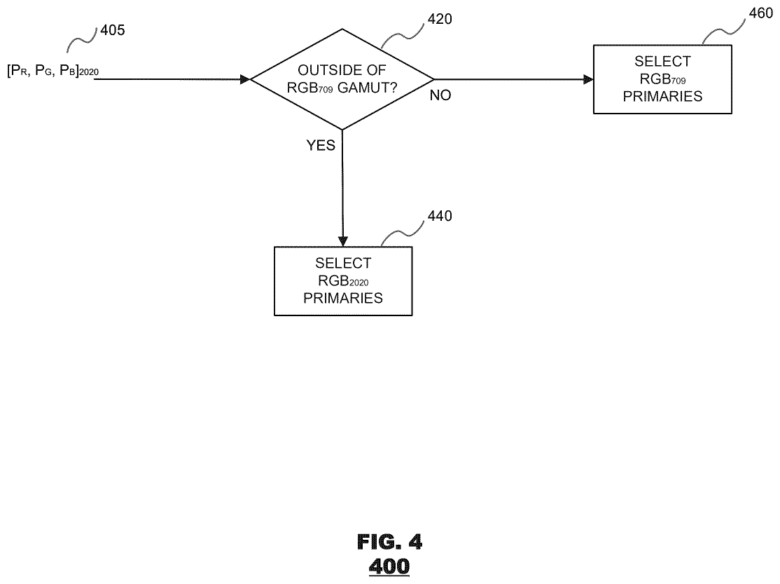

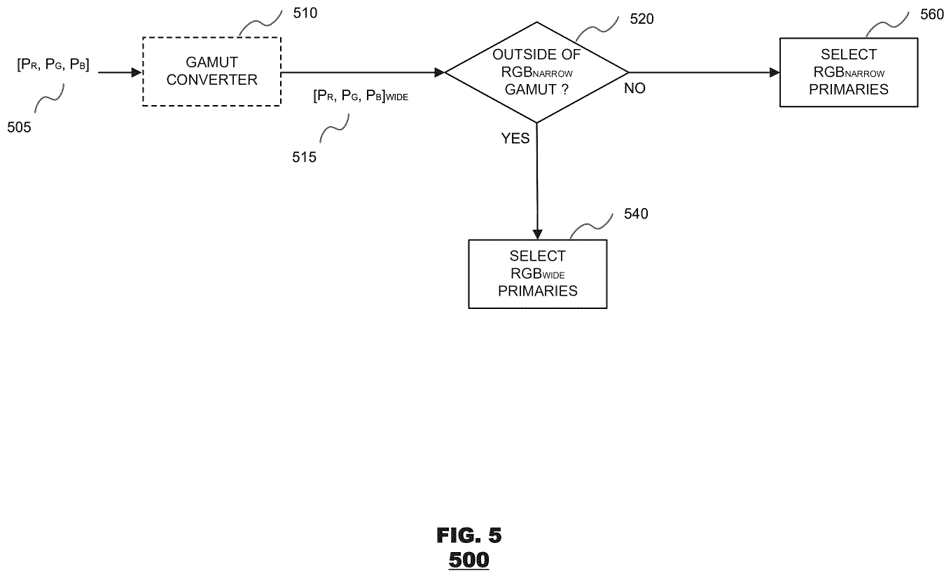

Hence, to reproduce a pixel 205 of a content to be displayed, subpixel units of a respective pixel unit 245 should be selected with the goal of reducing the consumed reproduction energy while meeting the pixel's chromaticity level. To that end, a subpixel unit selector 220 is employed by the pixel signal driver 250. Prior to that, in a case where the content to be displayed is within a color space that is not consistent with the display's color gamut (e.g., a color space that extends beyond the widest color gamut of the display), the pixel 205 may be converted by a gamut converter 210, as further described in reference to FIG. 5. Then, based on the pixel 205 (or its converted version), the subpixel unit selector 220 selects the subpixel units that will be used in the reproduction of the color components of that pixel. The color components of the pixel 205 are then channeled, via a demultiplexer 230, to the selected respective subpixel units. For example, a pixel's color components, [P_{R}, P_{G}, P_{B}], with low chromaticity may be channeled to selected subpixel units R_{N} 262, G_{N} 264, and B_{N} 266, respectively. While a pixel's color components, [P_{R}, P_{G}, P_{B}], with high chromaticity may be channeled to selected subpixel units R_{W} 252, G_{W} 254, and B_{W} 254, respectively. Various techniques can be employed to select a combination of the subpixel units that will be used for the reproduction of a pixel signal 205, as further disclosed herein in reference to FIGS. 4-11.

FIG. 4 is a flowchart of an example method 400 for selecting primaries of a multi-primary display utilizing BT.2020 and BT.709 gamuts, employable by the pixel signal driver 250 of FIG. 2. The method 400 receives an input pixel including color components [P_{R}, P_{G}, P_{B}]₂₀₂₀ 405, that is, a pixel signal 205 of a content within a color space that is consistent with a BT.2020 gamut. Based on the input pixel 405, the method 400 determines whether RGB₇₀₉ primaries 460 or RGB₂₀₂₀ primaries 440 are to be used for the reproduction of that pixel 405. Where, subpixel units R_{N} 262, G_{N} 264, and B_{N} 266 correspond to the RGB₇₀₉ primaries and subpixel units R_{W} 252, G_{W} 254, and B_{W} 256 correspond to the RGB₂₀₂₀ primaries. Thus, if the input pixel 405 is outside the RGB₇₀₉ color gamut 420, the RGB₂₀₂₀ primaries are selected 440. In this case, the pixel chromaticity is high, and so these color components need to be reproduced by the selected R_{W} 252, G_{W} 254, and B_{W} 256 subpixel units. However, if the input pixel 405 is within the RGB₇₀₉ gamut 420, RGB₇₀₉ primaries are selected 460. In this case, the pixel chromaticity is low enough to be reproduced by the selected (energy efficient) R_{N} 262, G_{N} 264, and B_{N} 266 subpixel units.

In an aspect, to determine whether a pixel's color components [P_{R}, P_{G}, P_{B}] of a content that adheres to a wide color gamut (such as the RGB₂₀₂₀ color gamut) are outside or are within a narrower color gamut (such as the RGB₇₀₉ color gamut), the color components can be mapped (using a global conversion method) to the narrower color gamut space, where color components that were landed at a location not within the narrow gamut space are clipped. Thus, color components that were clipped can be determined to be residing at a location outside the narrow color gamut space. This approach may be used by techniques disclosed herein for selecting the primaries (subpixel units) of the multi-primary display, where a determination as to whether a pixel color is outside a certain color gamut has to be made (see FIGS. 4, 5, 8, and 10).

For example, the color conversion method presented in section 2 of the ITU-R Report BT.2407 can be used. Therein, a pixel color in the BT.2020 gamut space, denoted [P_{R}, P_{G}, P_{B}]₂₀₂₀ can be converted into a corresponding pixel color in the BT.709 gamut space, [P_{R}, P_{G}, P_{B}]₇₀₉, by 1) converting [P_{R}, P_{G}, P_{B}]₂₀₂₀ from its non-linear representation into a linear space, obtaining a normalized pixel

$${[ {P}_{R}^{′} , {P}_{G}^{′} , {P}_{B}^{′} ]}_{2020} ;$$

next 2) multiplying

$${[ {P}_{R}^{′} , {P}_{G}^{′} , {P}_{B}^{′} ]}_{2020}$$

by a matrix M, obtaining a normalized pixel in the BT.709 gamut space,

$${[ {P}_{R}^{′} , {P}_{G}^{′} , {P}_{B}^{′} ]}_{709} ;$$

and, then, 3) converting

$${[ {P}_{R}^{′} , {P}_{G}^{′} , {P}_{B}^{′} ]}_{709}$$

back into the non-linear representation, obtaining [P_{R}, P_{G}, P_{B}]₇₀₉. In this color conversion method, color components that already resided within the BT.709 gamut space are not altered by the conversion operation. While color components that resided outside the BT.709 gamut space are clipped if, for example, after the multiplication by the matrix M, the values of

$${[ {P}_{R}^{′} , {P}_{G}^{′} , {P}_{B}^{′} ]}_{709}$$

are out of range (e.g., these values are clipped to zero or to one, if less than zero or greater than one, respectively). Such clipping may lead to a significant hue shift and loss of spatial detail for some of the color components, resulting in artefacts that may not meet the requirements for hue and spatial detail preservation. Therefore, as disclosed herein, detecting those color components of an input signal 405 that do not fit within a narrow color gamut, and then reproducing these color components using a combination of subpixel units that is associated with a color gamut that contains these color components is important to preserve these color components' chromaticity.

In the more general case, the display's primaries—that is, subpixel units 252, 254, 256 and subpixels 262, 264, and 266—may not correspond to the BT.2020 and the BT.709 standards, respectively. Furthermore, the input pixel signal 205 may be of a content that is not within a color space that is consistent with the display's wider gamut (that is, the gamut corresponding to subpixel units R_{W} 252, G_{W} 254, and B_{W} 256). Aspects of such case are described next in reference to FIG. 5.

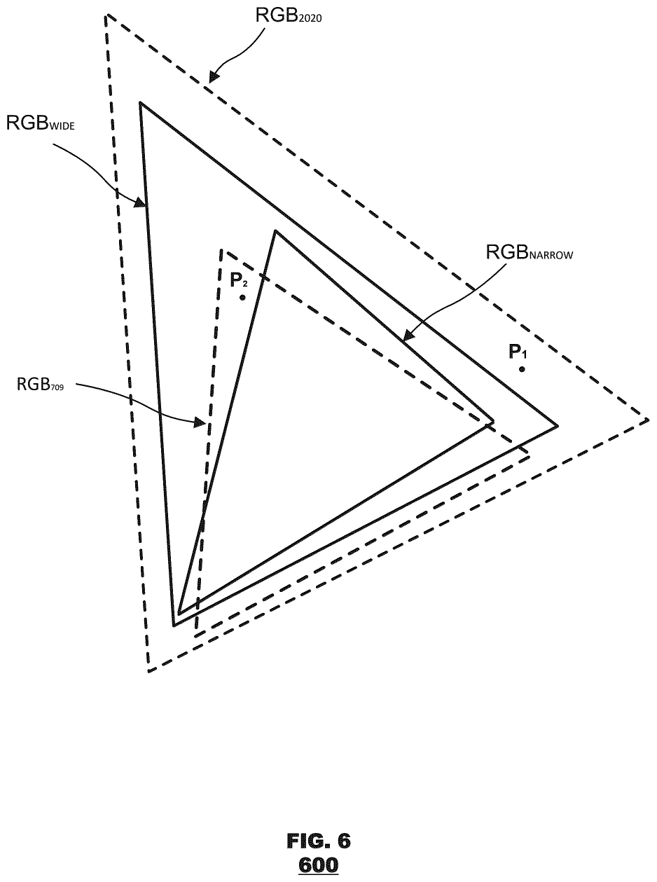

FIG. 5 is a flowchart of an example method 500 for selecting primaries of a multi-primary display utilizing narrow and wide gamuts, employable by the pixel signal driver 250 of FIG. 2. Note that in this case the display's primaries associated with the narrow gamut 262, 264, 266 do not correspond to BT.709, but to an arbitrary (e.g., proprietary) color space, denoted RGB_{narrow}, and that the display's primaries associated with the wide gamut 252, 254, 256 do not correspond to BT.2020, but to an arbitrary (e.g., a proprietary) color space, denoted RGB_{wide}. Furthermore, the input pixel 505 may be of a content that does not follow a color space that is consistent with the display's wider gamut RGB_{wide}. Therefore, a gamut converter 510 may be employed to map the input pixel 505 [P_{R}, P_{G}, P_{B}] into the color space of the RGB_{wide} gamut, resulting in input signal [P_{R}, P_{G}, P_{B}]_{WIDE} 515. For example, the input signal 505 may be of a content that follows a color space that is consistent with the BT.709 gamut or with the BT.2020 gamut, as demonstrated in FIG. 6.

As shown in FIG. 6, an input pixel P₁=[P_{R}, P_{G}, P_{B}]₁ can be located within the BT.2020 gamut, the illustrated RGB₂₀₂₀ gamut, that extends beyond the display's wide gamut, the illustrated RGB_{wide} gamut. In this case, when the displayed content adheres to BT.2020 gamut, input pixels can be converted, by the gamut converter 510, into the color space of the display, that is, the RGB_{wide} gamut. Similarly, as shown in FIG. 6, an input pixel P₂=[P_{R}, P_{G}, P_{B}] can be located within the BT.709 gamut, the illustrated RGB₇₀₉ gamut, but outside the display's narrow gamut, the illustrated RGB_{narrow}. In this case, when the displayed content adheres to BT.709 gamut, input pixels can also be converted, by the gamut converter 510, into the color space of the display, that is, the RGB_{wide} gamut. In an aspect, the gamut converter 510 may be configured to map the color space used by the input pixels 505 in a way that minimizes the change in color values within the display's narrow gamut, RGB_{narrow}. In the general case, when the input pixel 505 is of a content that does not follow a color space that is consistent with the color gamut that is spanned by all the subpixel units of the display, the input pixel 505 can be converted to that color space.

Back to FIG. 5, the input pixel [P_{R}, P_{G}, P_{B}] 505 (or its converted version [P_{R}, P_{G}, P_{B}]_{WIDE} 515, if the gamut converter 510 is employed) is processed by the method 500 to determine whether RGB_{narrow} primaries 560 or RGB_{wide} primaries 540 of the display are to be selected for the reproduction of the pixel's color. Note that, subpixel units R_{N} 262, G_{N} 264, and B_{N} 266 correspond to the RGB_{narrow} primaries and subpixel units R_{W} 252, G_{W} 254, and B_{W} 256 correspond to the RGB_{wide} primaries. Thus, if the input pixel (505 or 515) is outside the RGB_{narrow} gamut 520, RGB_{wide} primaries are selected 540 to reproduce color of the input pixel. Since, in this case, the pixel's chromaticity is high. To be able to reproduce this level of chromaticity, the pixel's color components need to be reproduced by the selected narrowband subpixel units: R_{W} 252, G_{W} 254, and B_{W} 256. However, if the input pixel (505 or 515) is within the RGB_{narrow} gamut 520, RGB_{narrow} primaries are selected 560. Since, in this case, the pixel's chromaticity is low, and so can be reproduced by the selected (energy efficient) broadband subpixel units: R_{N} 262, G_{N} 264, and B_{N} 266.

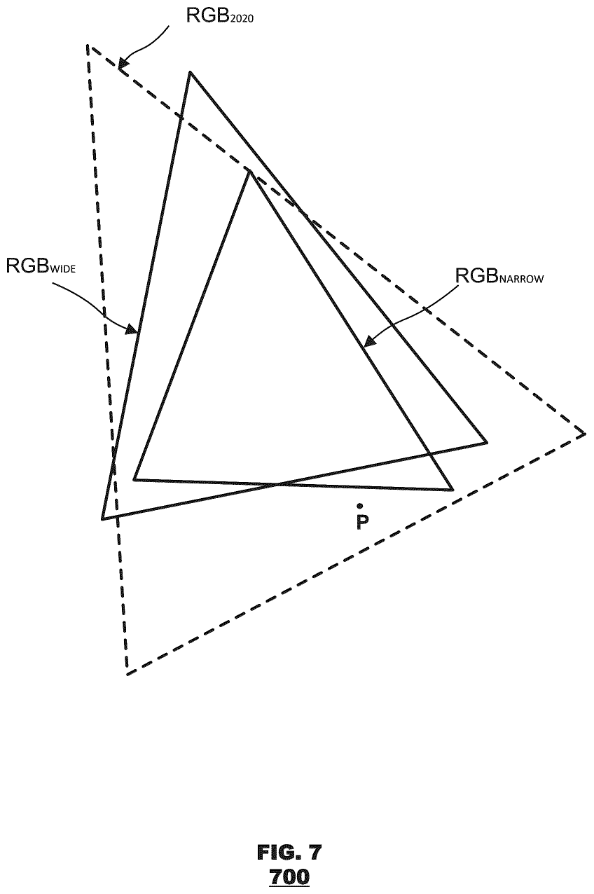

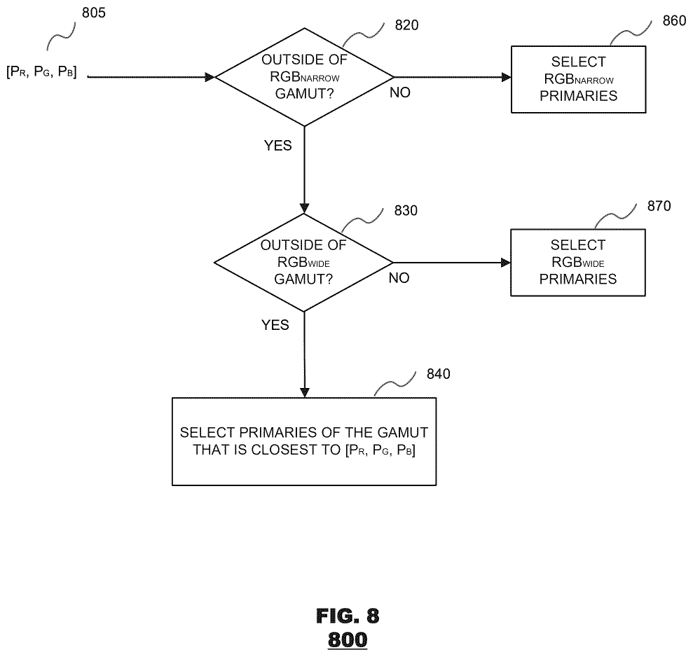

In an aspect of the present disclosure, there may be a situation where the content that is to be displayed contains pixels that are outside both the wide gamut and the narrow gamut of the display. Furthermore, some of these pixels may have a distance to the narrow gamut's boundary that is smaller than the distance to the wide gamut's boundary, as illustrated in FIG. 7. FIG. 7 shows three color gamuts: RGB₂₀₂₀ gamut, RGB_{wide} gamut, and RGB_{narrow} gamut. Assuming that the input pixels 205 of the content to be displayed are within a color space consistent with the RGB₂₀₂₀ gamut. In this case, as illustrated, an input pixel P may be located within the RGB₂₀₂₀ gamut, but outside the RGB_{wide} and RGB_{narrow} gamuts. Additionally, as in this case, P may be closer to the boundary of the RGB_{narrow} gamut than to the boundary of the RGB_{wide} gamut. Employing method 500 in this case (e.g., when the gamut convertor is disabled) may lead to a selection of the wide gamut primaries 540, instead of the more energy efficient selection of the narrow gamut primaries 560. Such a situation is addressed next in reference to FIG. 8.

FIG. 8 is a flowchart of an example method 800 for selecting primaries of a multi-primary display utilizing narrow and wide gamuts, employable by the pixel signal driver 250 of FIG. 2. In this example, the input pixel [P_{R}, P_{G}, P_{B}]₈₀₅ is of a content within a color space that is consistent with the RGB₂₀₂₀ gamut that extends beyond the RGB_{wide} gamut. Thus, the input pixel [P_{R}, P_{G}, P_{B}]₈₀₅ (e.g., pixel P in FIG. 7) is processed by the method 800 to determine whether RGB_{narrow} primaries 860 or RGB_{wide} primaries 870 of the display are to be selected for the pixel's reproduction. Note that subpixel units R_{N} 262, G_{N} 264, and B_{N} 266 correspond to the RGB_{narrow} primaries and subpixel units R_{W} 252, G_{W} 254, and B_{W} 256 correspond to the RGB_{wide} primaries. Hence, if the input pixel 805 is within the RGB_{narrow} gamut 820, RGB_{narrow} primaries are selected 860 to reproduce the input pixel. Otherwise, if the input pixel 805 is within the RGB_{wide} gamut 830, the RGB_{wide} primaries are selected 870 to reproduce the input pixel. However, if the input pixel 805 is outside both the RGB_{narrow} gamut 820 and the RGB_{wide} gamut 830, the method 800 selects 840 the primaries of the gamut that is closest to the input pixel [P_{R}, P_{G}, P_{B}]₈₀₅. As illustrated in FIG. 7, a first distance from P to the boundary of the RGB_{narrow} gamut can be measured as can be a second distance from P to the boundary of the RGB_{wide} gamut. If the first distance is shorter (or about the same as the second distance), the RGB_{narrow} primaries can be selected to reproduce the pixel, otherwise the RGB_{wide} primaries are selected to reproduce the pixel. As explained above, when the RGB_{narrow} primaries are selected more energy can be save in the reproduction of the pixel P.

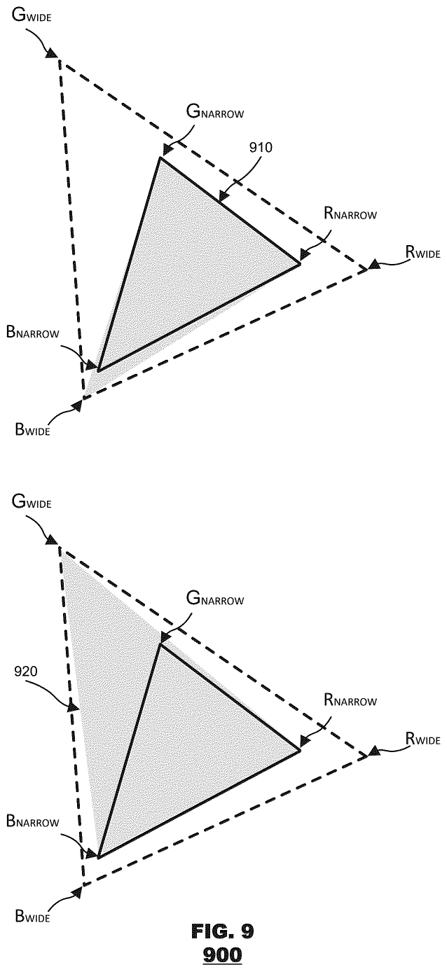

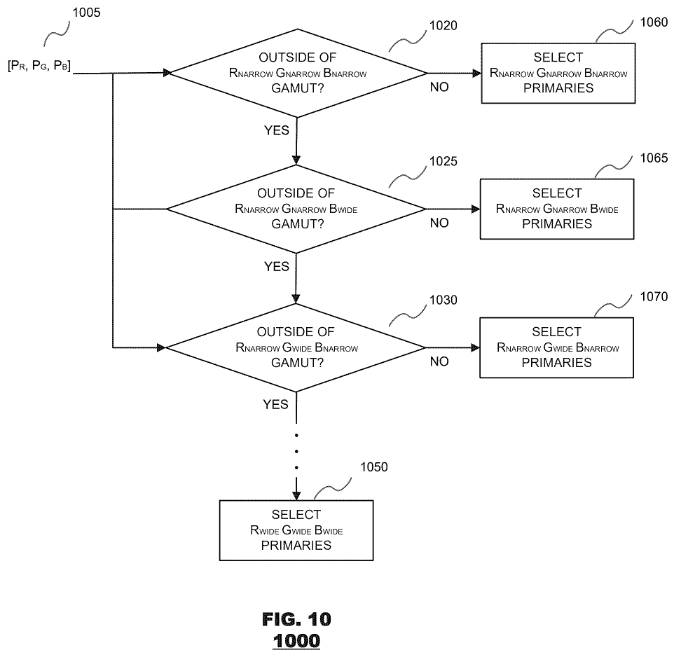

In another aspect of the present disclosure, a pixel of a content to be displayed 205 can be reproduced by a combination of the subpixel units, selected, for example, from both the narrow gamut subpixel units R_{N} 262, G_{N} 264, and B_{N} 266 and the wide gamut subpixel units R_{W} 252, G_{W} 254, and B_{W} 256. As described above with respect to FIGS. 4, 5, and 8, if an input pixel is outside the RGB_{narrow} gamut of the display, then none of the narrow gamut subpixel units R_{N} 262, G_{N} 264, and B_{N} 266 will be used and no saving in energy will be gained. This will be the case also when only one or only two color components of the input pixel [P_{R}, P_{G}, P_{B}] are outside the RGB_{narrow} gamut. For example, there may be a situation where only component P_{R} is highly chromatic, in which case, preferably, subpixel units R_{W} 252, G_{N} 264, and B_{N} 266 should be selected. In another example, there may be a situation where only components P_{R} and P_{B} are highly chromatic, in which case, preferably, subpixel units R_{W} 252, G_{N} 264, and B_{W} 256 should be selected. Likewise, other combinations of the subpixel units may be determined. Hence, a more efficient approach for selecting the subpixel units to reproduce a pixel color may be selecting a combination that consumes least energy. In an aspect, a combination of the subpixel units 1) with the largest collective spectral emission breadths and 2) with an associated color gamut that contains the pixel color may be selected, as further illustrated in reference to FIG. 9 and FIG. 10.

FIG. 10 is a flowchart of an example method 1000 for selecting primaries of a multi-primary display utilizing multiple gamuts, employable by the pixel signal driver 250 of FIG. 2. In this example, the input pixel [P_{R}, P_{G}, P_{B}] 1005 is of content to be displayed that is within a color space consistent with the RGB_{wide} gamut, illustrated by the dashed-line triangles R_{wide}G_{wide}B_{wide} in FIG. 9. In cases where the content to be displayed is within a color space consistent with other gamuts, a gamut converter 510 can be employed, as explained in reference to FIG. 5. Thus, the input pixel [P_{R}, P_{G}, P_{B}] 1005 is processed by the method 1000 to determine what combination of primaries (subpixel units) should be selected for the pixel's color reproduction (what combination will consume the least energy). Accordingly, if the input pixel 1005 is within the RGB_{narrow} gamut 1020 (the gamut confined by triangle R_{narrow} G_{narrow} B_{narrow} in FIG. 9), the combination of the primaries R_{narrow}, G_{narrow}, and B_{narrow} is selected 1060. That is, subpixel units R_{N} 262, G_{N} 264, and B_{N} 266 are used to reproduce the input pixel. Otherwise, for example, if the input pixel 1005 is within the gamut confined by triangle R_{narrow} G_{narrow} B_{wide} 1025 (illustrated by the shaded triangle 910 in FIG. 9), the combination of the primaries R_{narrow}, G_{narrow}, and B_{wide} is selected 1065. That is, subpixel units R_{N} 262, G_{N} 264, and B_{W} 256 are used to reproduce the input pixel. Otherwise, for example, if the input pixel 1005 is within the gamut confined by triangle R_{narrow} G_{wide} B_{narrow} 1030 (illustrated by the shaded triangle 920 in FIG. 9), the combination of the primaries R_{narrow}, G_{wide}, and B_{narrow} is selected 1070. That is, subpixel units R_{N} 262, G_{W} 254, and B_{N} 266 are used to reproduce the input pixel. Similarly, the method 1000 may proceed with respect to other combinations (that is, R_{narrow}, G_{wide}, and B_{wide}; R_{wide}, G_{narrow}, and B_{narrow}; R_{wide}, G_{narrow}, and B_{wide}; R_{wide}, G_{wide}, and B_{narrow}) until it reverts to selecting the combination of primaries R_{wide}, G_{wide}, and B_{wide} 1050 in which subpixel units R_{W} 252, G_{W} 254, and B_{W} 256 are used to reproduce the input pixel. Following this method 1000, the overall usage of the more efficient subpixel units R_{N} 262, G_{N} 264, and B_{N} 266 is increased when reproducing the content to be displayed.

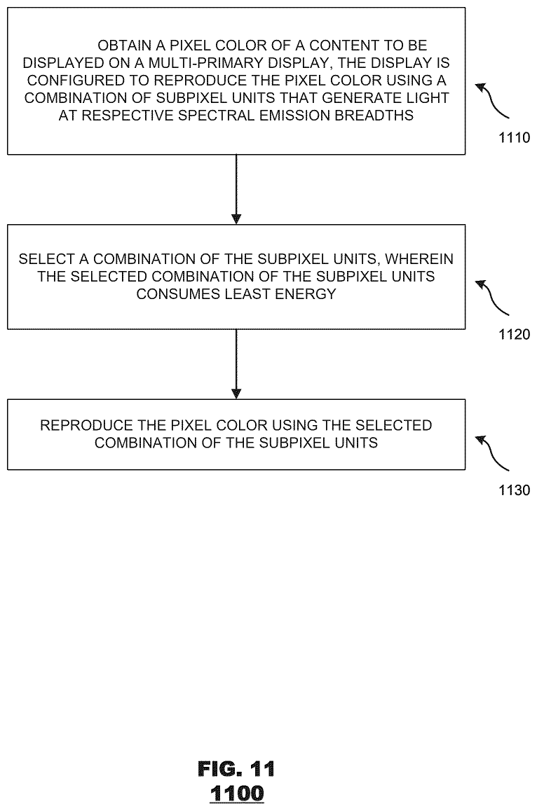

FIG. 11 is a flowchart of an example method 1100 for driving a multi-primary display, according to aspects of the present disclosure. The method 1100 begins, in step 1110, with obtaining a pixel color 205 of a content to be displayed on the display panel 240. The display panel is configured to reproduce a pixel color using a combination of subpixel units 245 that generate light at respective spectral emission breadths. Receiving a pixel color, the method 1100 proceeds, in step 1120, by selecting a combination of the subpixel units (or a combination of the respective primaries). Where the selected combination of the subpixel units is the combination that consumes least energy. In an aspect, the selected combination is the combination of the subpixel units with the largest collective spectral emission breadths (that is, with the largest sum of spectral emission breadths) and with an associated color gamut that contains the pixel color. The pixel color, in step 1130, is then reproduced using the selected combination of the subpixel units. The manner in which the combination of the subpixel units is selected is disclosed herein with respect to FIGS. 4, 5, 8, and 10.

The illustrations of the aspects described herein are intended to provide a general understanding of the structure, function, and operation of the various aspects. The illustrations are not intended to serve as a complete description of all of the elements and features of apparatuses and systems that utilize the structures or methods described herein. Many other aspects may be apparent to those of skill in the art upon reviewing the disclosure. Other aspects may be utilized and derived from the disclosure, such that structural and logical substitutions and changes may be made without departing from the scope of the disclosure. Accordingly, the disclosure and the figures are to be regarded as illustrative rather than restrictive.

The description of the aspects is provided to enable the making or use of the aspects. Various modifications to these aspects will be readily apparent, and the generic principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

1. A method for driving a multi-primary display, comprising:
obtaining a pixel color of a content to be displayed, the display is configured to reproduce the pixel color using a combination of subpixel units that generate light at respective spectral emission breadths;
selecting a combination of the subpixel units, wherein the selected combination of the subpixel units consumes least energy; and
reproducing the pixel color using the selected combination of the subpixel units.

2. The method according to claim 1, wherein the selected combination of the subpixel units is with the largest collective spectral emission breadths and with an associated color gamut that contains the pixel color.

3. The method according to claim 1, wherein the selecting of a combination of the subpixel units comprises:
mapping the pixel color into the color space of a color gamut associated with a combination of the subpixel units; and
determining that the pixel color is outside the color gamut if the pixel color has been clipped by the mapping.

4. The method according to claim 1, wherein:
the subpixel units comprise a first group of subpixel units with wide emission spectrum associated with a narrower gamut and a second group of subpixel units with narrow emission spectrum associated with a wider gamut; and
the selecting a combination of the subpixel units comprises selecting the first group if the narrower gamut contains the pixel color.

5. The method according to claim 4, wherein the narrower gamut is according to the BT. 709 standard and the wider gamut is according to the BT.2020 standard.

6. The method according to claim 1, wherein:
the subpixel units comprise a first group of subpixel units with wide emission spectrum associated with a narrower gamut and a second group of subpixel units with narrow emission spectrum associated with a wider gamut; and
the selecting a combination of the subpixel units comprises selecting the first group if the pixel color is closer to the narrower gamut than to the wider gamut.

7. The method according to claim 1, wherein the subpixel units generate light of respective colors, including red, green, blue, yellow, purple, cyan, white, or a combination thereof.

8. The method according to claim 1, further comprising:
before the selecting, converting the pixel color into a color space within a color gamut spanned by the subpixel units.

9. An apparatus for driving a multi-primary display, comprising:
at least one processor; and
memory storing instructions that, when executed by the at least one processor, cause the apparatus to:
obtain a pixel color of a content to be displayed, the display is configured to reproduce the pixel color using a combination of subpixel units that generate light at respective spectral emission breadths,
select a combination of the subpixel units, wherein the selected combination of the subpixel units consumes least energy, and
reproduce the pixel color using the selected combination of the subpixel units.

10. The apparatus according to claim 9, wherein the selected combination of the subpixel units is with the largest collective spectral emission breadths and with an associated color gamut that contains the pixel color.

11. The apparatus according to claim 9, wherein the selecting of a combination of the subpixel units comprises:
mapping the pixel color into the color space of a color gamut associated with a combination of the subpixel units; and
determining that the pixel color is outside the color gamut if the pixel color has been clipped by the mapping.

12. The apparatus according to claim 9, wherein:
the respective subpixel units comprise a first group of subpixel units with wide emission spectrum associated with a narrower gamut and a second group of subpixel units with narrow emission spectrum associated with a wider gamut; and
the selecting a combination of the subpixel units comprises selecting the first group if the narrower gamut contains the pixel color.

13. The apparatus according to claim 12, wherein the narrower gamut is according to the BT. 709 standard and the wider gamut is according to the BT.2020 standard.

14. The apparatus according to claim 9, wherein:
the subpixel units comprise a first group of subpixel units with wide emission spectrum associated with a narrower gamut and a second group of subpixel units with narrow emission spectrum associated with a wider gamut; and
the selecting a combination of the subpixel units comprises selecting the first group if the pixel color is closer to the narrower gamut than to the wider gamut.

15. The apparatus according to claim 9, wherein the subpixel units generate light of respective colors, including red, green, blue, yellow, purple, cyan, white, or a combination thereof.

16. The apparatus according to claim 9, wherein the instructions further cause the system to:
before the selecting, convert the pixel color into a color space within a color gamut spanned by the subpixel units.

17. (canceled)

18. A multi-primary display apparatus, comprising:
a display panel including pixel units, wherein a pixel unit, of the pixel units, is configured to reproduce a respective pixel color and comprises subpixel units configured to generate light at respective spectral emission breadths.

19. The apparatus according to claim 17, further comprising:
a driver, configured to select a combination of the subpixel units of the pixel unit,
wherein the selected combination of the subpixel units consumes least energy, and
wherein the selected combination of the subpixel units is used to reproduce the pixel color.

20. The apparatus according to claim 18, wherein the selected combination of the subpixel units is with the largest collective spectral emission breadths and with an associated color gamut that contains the pixel color.

21. (canceled)

22. The apparatus according to claim 18, wherein:
the subpixel units comprise a first group of subpixel units with wide emission spectrum associated with a narrower gamut and a second group of subpixel units with narrow emission spectrum associated with a wider gamut; and
the selecting of a combination of the subpixel units comprises selecting the first group if the narrower gamut contains the pixel color.

23-24. (canceled)
